(19) United States
(12) Patent Application Publication
(10) Pub. No.: US 2009/0196459 A1
(43) Pub. Date: Aug. 6, 2009

(54) Image manipulation and processing techniques for remote inspection device

(75) Inventors: Brandon Watt, Hartland, MI (US); Al Boehnlein, Ypsilanti, MI (US); Tye Newman, Howell, MI (US); Paul J. Eckhoff, Fenton, MO (US); Jeffrey J. Miller, Northville, MI (US); Jeff Schober, Sterling Heights, MI (US)

Correspondence Address: HARNESS, DICKEY & PIERCE, P.L.C., P.O. BOX 828, BLOOMFIELD HILLS, MI, 48303, US

(73) Assignee: Perceptron, Inc.

(21) Appl. No.: 12/074,218

(22) Filed: Feb. 29, 2008

Related U.S. Application Data
(60) Provisional application No. 61/063,463, filed on Feb. 1, 2008.

(51) Int. Cl. G06K 9/00

(52) U.S. Cl. 382/103

(57) ABSTRACT

A remote inspection apparatus has an imager disposed in an imager head and capturing image data. An active display unit receives the image data in digital form and graphically renders the image data on an active display. Movement tracking sensors track movement of the imager head and/or image display unit. In some aspects, a computer processor located in the active display unit employs information from movement tracking sensors tracking movement of the imager head to generate and display a marker indicating a position of the imager head. In additional aspects, the computer processor employs information from movement tracking sensors tracking movement of the active display unit to control movement of the imager head. In other aspects, the computer processor employs information from movement tracking sensors tracking movement of the active display unit to modify the image data rendered on the active display.

### CROSS-REFERENCE TO RELATED APPLICATIONS

This application claims the benefit of U.S. Provisional Application No. 61/063,463, filed on Feb. 1, 2008. The disclosure of the above application is incorporated herein by reference.

### FIELD

The present disclosure relates generally to borescopes and video scopes.

### BACKGROUND

Borescopes and video scopes for inspecting visually obscured locations are typically tailored for particular applications. For instance, some borescopes have been tailored for use by plumbers to inspect pipes and drains. Likewise, other types of borescopes have been tailored for use by mechanics to inspect interior compartments of machinery being repaired.

The statements in this section merely provide background information related to the present disclosure and may not constitute prior art.

### SUMMARY

A remote inspection apparatus has an imager disposed in an imager head and capturing image data. An active display unit receives the image data in digital form and graphically renders the image data on an active display. Movement tracking sensors track movement of the imager head and/or image display unit. In some aspects, a computer processor located in the active display unit employs information from movement tracking sensors tracking movement of the imager head to generate and display a marker indicating a position of the imager head. In additional aspects, the computer processor employs information from movement tracking sensors tracking movement of the active display unit to control movement of the imager head. In other aspects, the computer processor employs information from movement tracking sensors tracking movement of the active display unit to modify the image data rendered on the active display.

Further areas of applicability will become apparent from the description provided herein. It should be understood that the description and specific examples are intended for purposes of illustration only and are not intended to limit the scope of the present disclosure.

### DRAWINGS

FIG. 1, including FIGS. 1A-1F, is a set of views illustrating a handheld, remote user interface for use with a remote inspection device.

FIG. 2, including FIGS. 2A-2C is a diagram illustrating remote inspection devices.

FIG. 3A is a perspective view illustrating an imager head having multiple imagers and imager movement sensors.

FIG. 3B is a cross-sectional view illustrating the imager head of FIG. 3A.

FIG. 4 is a block diagram illustrating a modular remote inspection device system.

FIG. 5 is a flow diagram illustrating determination of a 3D imager head position.

FIG. 6 is a flow diagram illustrating a method of operation for the modular remote inspection device system of FIG. 4.

FIG. 7, including FIGS. 7A and 7B, are views of images of pipe interiors captured and/or rendered according to multiple, user selectable modes.

FIG. 8, including FIGS. 8A and 8B, are views illustrating display of markers indicating imager head location information.

The drawings described herein are for illustration purposes only and are not intended to limit the scope of the present disclosure in any way.

### DETAILED DESCRIPTION

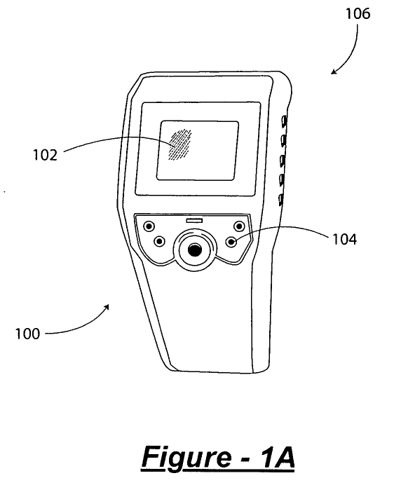

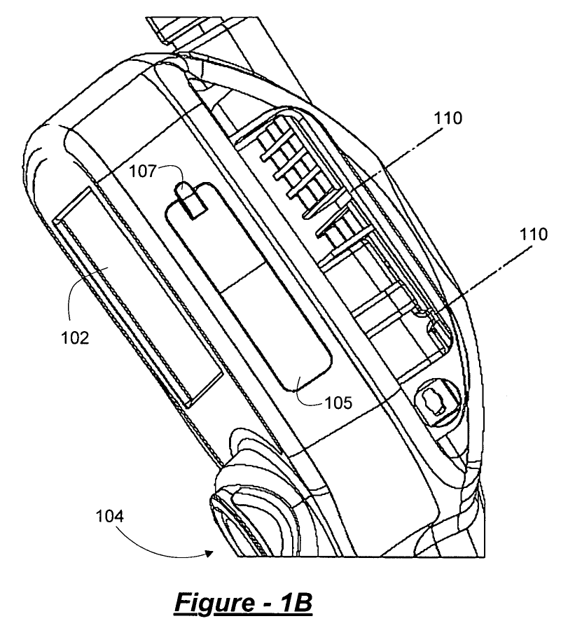

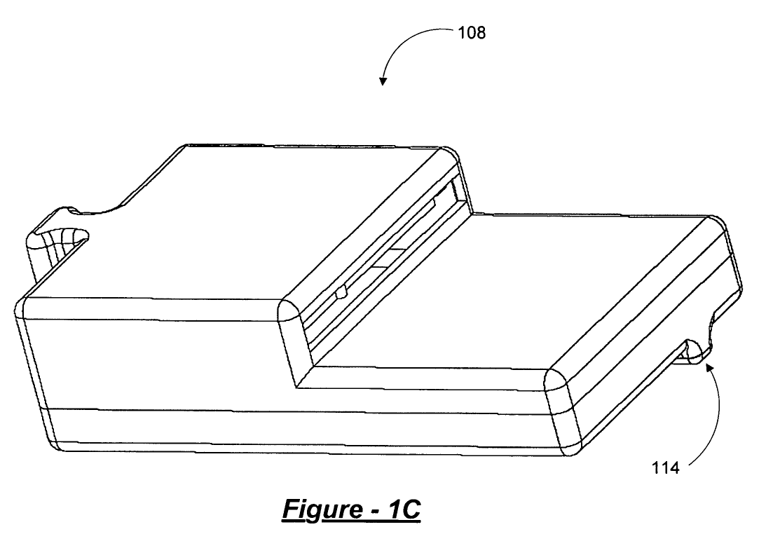

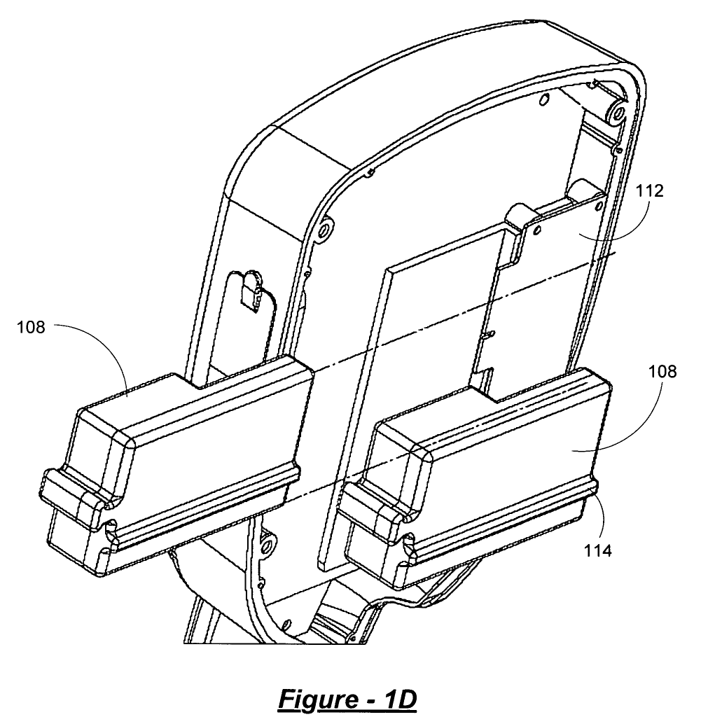

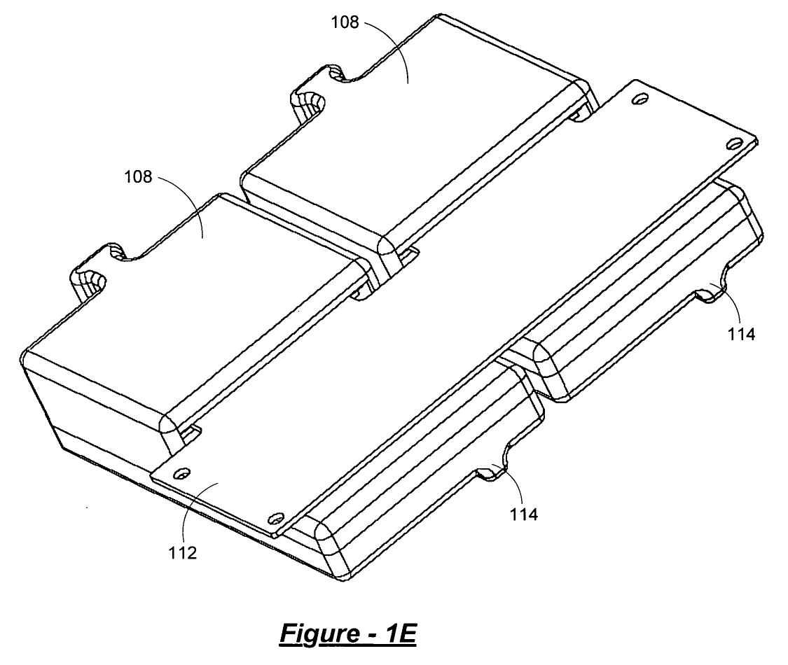

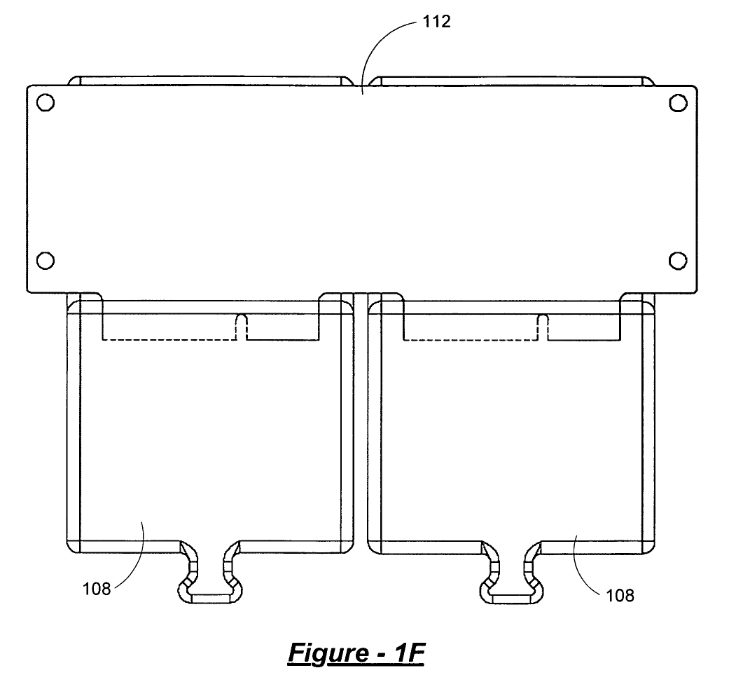

Referring generally to FIGS. 1A-1F, a handheld user interface 100 for use with a remote inspection device has one or more output components such as an active display 102. A number of user interface input components 104 are also provided, such as buttons, joysticks, push pads and the like. In some embodiments, the user interface 100 can include a gyroscope, accelerometer, and/or GPS, such as differential GPS. Connection mechanisms 104, such as number of data ports and/or docking bays, can also be provided.

In some embodiments, data ports of the connection mechanisms 104 can include USB ports, Fire-wire ports, Bluetooth, and the like. These data ports can be located within a chamber of the user interface that is protected by a cover 105, such as a rubber grommet or the like. In some embodiments, the cover 105 can have a tab 107 facilitating user removal of the cover. In additional or alternative embodiments, the cover 105 can be attached on one end to an edge of the chamber opening by a hinge to ensure that the cover 105 is not lost when removed.

In additional or alternative embodiments, a docking bay of connection mechanisms 106 includes an expansion card docking bay that holds two expansion cards 108. The docking bay uses a keyway 110 to guide insertion of the expansion cards 108 and hold them in place on board 112. The expansion cards 108 have a rail 114 that fits within the keyway 110. The expansion cards also have a grasp facilitation component 116 that facilitates user manipulation and guides orientation of the cards 108.

Turning now to FIG. 2A, an embodiment of a remote inspection device is generally comprised of three primary components: a digital display housing 28, a digital imager housing 24, and a flexible cable 22 interconnecting the digital display housing 28 and the digital imager housing 24. The flexible cable 22 is configured to bend and/or curve as it is pushed into visually obscured areas, such as pipes, walls, etc. The flexible cable 22 is a ribbed cylindrical conduit having an outer diameter in the range of 1 cm. The conduit is made of either a metal, plastic or composite material. Smaller or larger diameters are suitable depending on the application. Likewise, other suitable constructions for the flexible cable 22 are also contemplated by this disclosure.

The digital imager housing 24 is coupled to a distal end of the flexible cable 22. The digital imager housing 24 is a substantially cylindrical shape that is concentrically aligned with the flexible cable 22. However, it is envisioned that the digital imager housing 24 takes other shapes. In any case, an outer diameter of the cylindrical digital imager housing 104 is preferably sized to be substantially equal to or less than the outer diameter of the flexible cable 102.

A digital imaging device 26 is embedded in an outwardly facing end of the cylindrical digital imager housing 24. The digital imaging device 26 captures an image of a viewing area proximate to the distal end of the flexible cable 22 and converts the image into a digital video signal. In some embodiments, an attachment 30 is removably coupled to the digital imager housing 14.

The digital imaging device 106 requires relatively more signal wires than a non-digital imaging device. Therefore, and referring now to FIG. 9A, a digital video signal conversion device is included in the digital imager housing 24 in order to serialize the digital video signal and thereby reduce the number of wires required to be threaded through the flexible cable 22 (see FIG. 2A). For example, and with particular reference to FIG. 9A, the number of wires required to transmit the video signal from the digital imager housing to the digital display can be reduced from eighteen wires to eight wires by using a differential LVDS serializer 32 in the digital imager housing 24 to reformat the digital video signal 34 to a differential LVDS signal 36. Then, a differential LVDS deserializer 38 in the digital display housing 28 receives the LVDS signal 36 and converts it back to the digital video signal 34 for use by the digital video display. In this case, the LVDS signal 36 replaces the twelve wires required to transmit the digital video signal with two wires required to transmit the LVDS signal. Six more wires are also required: one for power, one for ground, two for the LED light sources, one for a serial clock signal, and one for a serial data signal. One skilled in the art will recognize that the serial clock signal and the serial data signal are used to initiate the digital imaging device 26 at startup. In some additional or alternative embodiments, it is possible to reduce the number of wires even further by known techniques.

Referring now to FIG. 9B, in another embodiment a digital to analog converter 40 in the digital imager housing 24 converts the digital video signal 34 to an analog video signal 42. This analog video signal 42 is in turn received by analog to digital converter 44 in the display housing 28, and is converted back to the digital video signal 34. Like use of a serializer, the use of the analog to digital converter reduces the number of wires from eighteen wires to eight wires. Again, two wires are needed to provide the analog voltage signal.

Referring now to FIG. 9C, in yet another embodiment the digital video signal 34 is converted to an NTSC/PAL signal 48 by a video encoder 46 in the digital imager housing 24. One skilled in the art will readily recognize that NTSC is the standard for television broadcast in the United States and Japan, while PAL is its equivalent European standard. This NTSC/PAL signal 48 is then reconverted to digital video signal 34 by video decoder 50 of display housing 28.

Returning the digital video signal to its original form allows use of a digital display to render the video captured by the digital imaging device 104. Use of the digital display can leverage various capabilities of such displays. For example, digital pan and zoom capability can be acquired by use of a larger imager in terms of pixels than the display, or by digital zoom. Thus, the display can be moved for greater detail/flexibility within the fixed visual cone of the imager head. Also, a software toggle can be implemented to increase perceived clarity and contrast in low spaces by switching from color to black and white.

Turning now to FIG. 2B, another embodiment of the modular remote inspection device 20 has a remote digital imager housing 28. In this instance, the remote housing 28 is configured to be held in another hand of the user of the inspection device 20, placed aside, or detachably attached to the user's person or a convenient structure in the user's environment. The flexible cable 22 is attached to and/or passed through a push stick housing 52 that is configured to be grasped by the user. A series of ribbed cylindrical conduit sections 22A-22C connects the push stick housing 52 to the cylindrical digital imager housing 24. One or more extension sections 22B are detachably attached between sections 22A and 22C to lengthen the portion of flexible cable 22 interconnecting push stick housing 52 and digital imager housing 24. It should be readily understood that the sections 22A-C can also be used in embodiments like those illustrated in FIG. 2A in which the digital display housing 28 is not remote, but is instead combined with push stick housing 52.

Returning to FIG. 2B, the flexible cable passes through push stick housing 52 to digital display housing 28. For example, a coiled cable section 22D extending from push stick housing 52 connects to a ribbed cylindrical conduit section 22E extending from digital display housing 28. Thus, flexible cable 22 carries a serialized digital video signal from digital imaging device 26 through the ribbed cylindrical conduit sections 22A-22C to push stick housing 52, through which it is transparently passed through to the remote digital video display housing 28 by the coiled cable section 22D and the ribbed cylindrical conduit section 22E. It should be readily understood that one or more extension sections 22B can be used to lengthen either or both of the cable portions interconnecting the push stick housing 52 with the digital display housing 28 and the digital imager housing 24.

Another embodiment is envisioned in which flexible cable 22 terminates at the push stick housing 52, and push stick housing 52 includes a wireless transmitter device, thereby serving as a transmitter housing. In such an embodiment, it should be readily understood that digital display housing 28 contains a wireless receiver device, and the serialized digital video signal is transmitted wirelessly from the push stick housing 52 to the digital display housing 28. It should also be readily understood that one or more antennas are provided to the push stick housing 52 and the digital display housing 28 to facilitate the wireless communication. Types of wireless communication suitable for use in this embodiment include Bluetooth, 802.11(b), 802.11(n), wireless USB, and others.

Referring generally to FIGS. 2A-2C some embodiments of the remote inspection device 200 have virtual reality and/or augmented reality display functionality. In one or more of these embodiments, movement tracking sensors located in a display unit and imager head provide information useful for determining display unit position and orientation and/or imager head position and orientation. Display unit movement tracking sensors are disposed in the display unit. Example display unit movement tracking sensors include an accelerometer, gyroscope, sonar technology with triangulation, differential GPS, gimbal, and/or eyeball ballast. Imager head movement tracking sensors are disposed in the imager head, the motorized reel, and/or in the display unit. Example imager head movement tracking sensors disposed in the imager head include an accelerometer, gyroscope, optical mouse, sonar technology with triangulation, differential GPS, gimbal, and/or eyeball ballast. Example imager head movement tracking sensors disposed in the reel include a deployment sensor tracking movement of a cable feeding and retracting the imager head. Example imager head movement tracking sensors disposed in the display unit include a software module extracting motion vectors form video captured by an imager in the imager head.

In some of these embodiments, information about the imager head position and orientation is used to generate and render a marker on an active display that indicates the imager head position and orientation to the user. Example markers include 3D coordinates of the imager head, an icon indication position and orientation of the imager head, and a 3D path of the imager head. The marker is directly rendered to the active display. The marker is also rendered to an augmented reality display by using the position and orientation of the display to dynamically display the marker to communicate a path and position of the imager head in the user's environmental surroundings.

In some embodiments, the information about the display position and orientation is employed to control the imager head movement. In this respect moving the display housing from side to side articulates the angle of the imager head. Micro-motors in the imager head, flex-wire cable, and/or wired cable are used to articulate the imager head. In some embodiments, moving the display housing forward and backwards feeds and retracts the imager head using a motorized cable reel.

In some embodiments, the information about the position and orientation of the display housing is used to post process the digital images. This post processing is performed to pan, zoom, and/or rotate the digital image. In some embodiments, the information about the position of the imager head is used to rotate the image in order to obtain an “up is up” display of the digital image.

Referring now particularly to FIG. 2C, a user interface embodied as a handheld display 202 has user interface input components to control position of one of imager heads 204. Additionally, handheld display 202 has sensors, such as an accelerometer, gyroscope, gimbal, and/or eyeball ballast, for tracking movement of the handheld display 202. In a mode of operation selected by a user, the sensed movement of the handheld display 202 is also employed to control position of the imager head 204. In another mode of operation selected by the user, the user interface input components and sensed movement of the handheld display 202 are employed to process (e.g., pan, zoom, etc.) captured images displayed by handheld display 202. Captured images that are not processed are additionally communicated to a remote display 205. In a further mode of operation selected by the user, sensed movement of the handheld display is employed to process captured images, while the user interface input components are employed to control position of the one or more imager heads. In an additional mode of operation selected by the user, the sensed movement of the handheld display is employed to control position of the one or more imager heads, while the user interface input components are employed to control processing of the captured images.

One mechanism for positioning the head includes a motorized cable reel 208 that feeds and/or retracts the head by feeding and/or retracting the cable. Other mechanisms suitable for use in positioning the imager head include micro-motors in the imager head that articulate the imager and/or imager head, wires in a cable section 206 that articulate the imager head 204, and/or flex-wire of the cable section that articulates the imager head 204.

Reel 208 can include a wireless transmitter device, thereby serving as a transmitter housing. It should be readily understood that digital display housing 202 contains a wireless receiver device, and that a serialized digital video signal is transmitted wirelessly from the reel 208 to the handheld display 202. Types of wireless communication suitable for use with the remote inspection device include Bluetooth, 802.11(b), 802.11(g), 802.11(n), wireless USB, Xigbee, analog, wireless NTSC/PAL, and others.

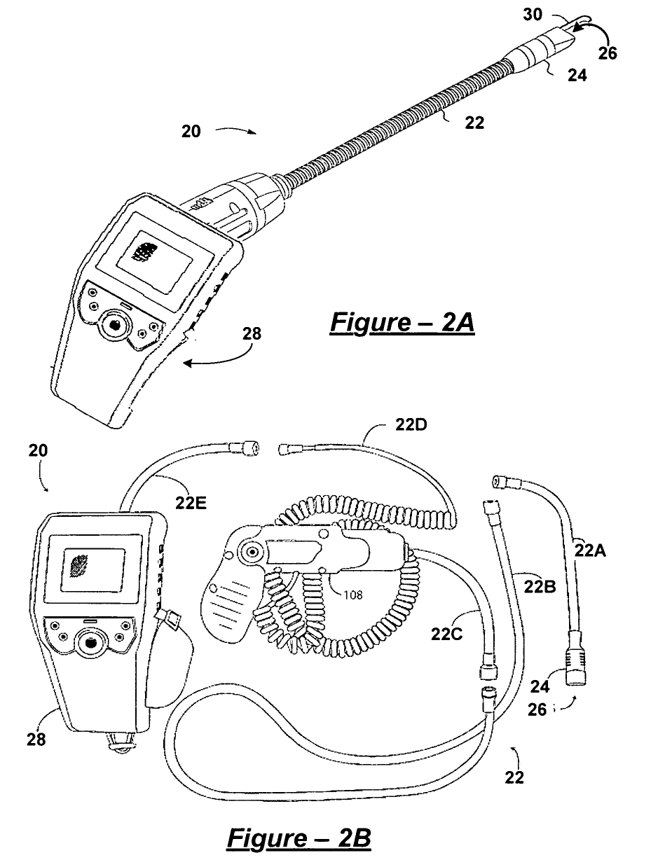

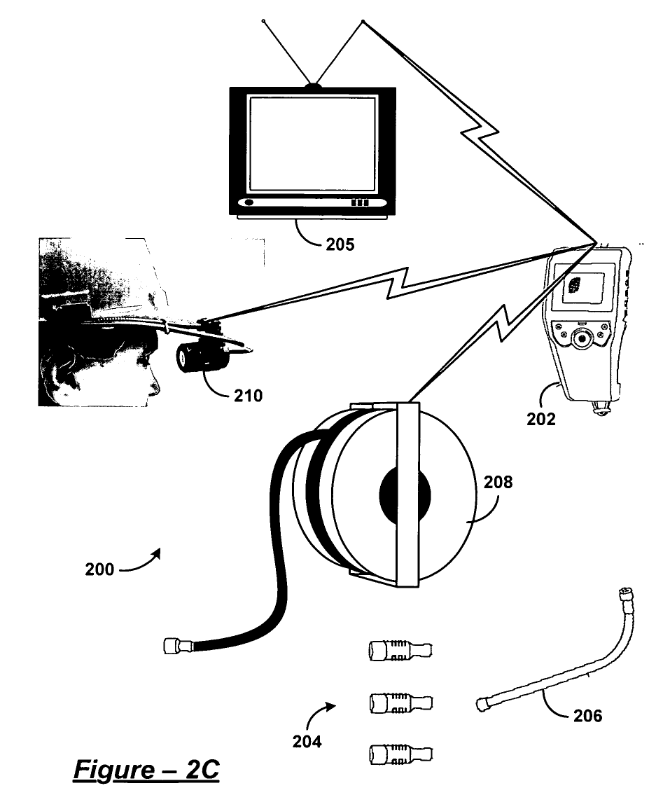

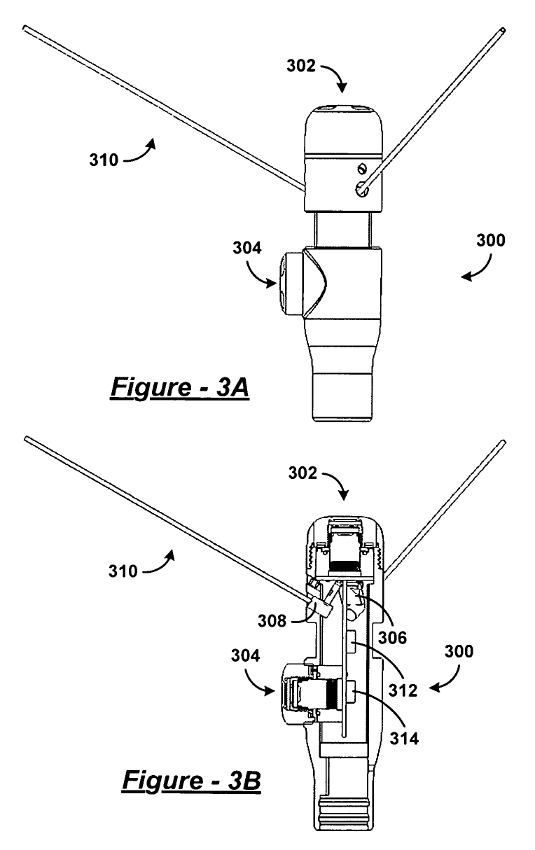

As described further below with reference to FIG. 3, two or more light sources protrude from an outwardly facing end of the cylindrical imager head 300 along a perimeter of one or more imagers 302 and/or 304. The imagers 302 and/or 304 are recessed directly or indirectly between the light sources. The light sources are super bright LEDs. Super bright LEDs suitable for use with the imager head include Nichias branded LEDs. The super bright LEDs produce approximately twelve times the optical intensity compared to standard LEDs. Specifically, super bright LEDs, such as 5 mm Nichias LEDs, produce upwards of 1.5 lumens each. The inclusion of the super bright LEDs produces a dramatic difference in light output, but also produces much more heat than standard LEDs. Therefore, the imager housing includes a heat sink to accommodate the super bright LEDs.

A transparent cap encases the imagers 302 and 304 and light sources within the imager head 300. The transparent cap also provides imaging optics (i.e., layered transparent imager cap) in order to effectively pull the focal point of the one or more imagers 302 and/or 304 outward compared to its previous location. For a given shape imager head 300, this change in the focal point widens the effective field of view, thus rendering a snake formed of the flexible cable and imager head 300 more useful. This change in focal point also allows vertical offset of the one or more imagers 302 and 304 from the light producing LEDs, thus making assembly of a smaller diameter imager head 300 possible.

Returning briefly to FIG. 2C, various types of imager heads 204 are provided, each having different types and/or combinations of imaging devices, light sources, and/or imaging optics that are targeted to different types of uses. For example, one of the imager heads 204 lacks light sources and imaging optics. Also, one of the imager heads 204 has light sources producing relatively greater amounts light in the infrared spectrum than another of the imager heads provides. In this case, LEDs are employed that produce light in the infrared spectrum, and optical filters that selectively pass infra red light are included in the imaging optics. This infrared imaging head is especially well suited to night vision and increasing the view distance and detail in galvanized pipe. In another of the imager heads, light sources are omitted to accomplish a thermal imaging head that has an infrared filter. An additional one of the imager heads 204 has light sources capable of producing light in the ultraviolet spectrum. In this case, LEDs are employed that produce light in the ultraviolet spectrum, the imaging optics include an optical filter that selectively passes ultraviolet light. This ultraviolet imager head is especially well suited for killing bacteria and fluorescing biological materials. A further one of the imager heads 204 has white light sources. Moreover, at least one of the imager heads 204 has multiple imagers. One such imager head has a thermal imaging device and a visible spectrum imaging device. In this case, when the thermal imaging device is operated instead of the visible spectrum imaging device, visible light sources of the head is extinguished to allow thermal imaging. It should be readily understood, that any or all of the different types of imager heads 204 can be supplied separately or in any combination.

Digital display 202 stores software in computer readable memory and executes the software with a computer processor in order to operate the heads 204. The software for operating the heads 204 has various modes of operation for use in operating different types of the imager heads 204. The software for operating the digital display also has image processing capability to enhance images. The image processing capabilities are specific to different ones of the imager heads 204.

More information regarding the imager heads, embodiments employing a push stick instead of a reel, and other components that are employed in the aforementioned embodiments, alternative embodiments, or additional embodiments of the present disclosure can be found in U.S. patent application Ser. No. 11/645280, filed by the Assignee of the present invention on Dec. 22, 2006, published on Aug. 9, 2007 as U.S. Publication Number 2007/0185379, and entitled Modular Remote Inspection Device with Digital Imager. The aforementioned patent application and publication are incorporated herein in their entirety for any purpose.

One or more of imager heads 204 include environmental condition sensors. For example, one of the imager heads includes a temperature sensor. This sensed environmental condition information is communicated to the handheld display 202, head mounted display 210, and static display 205 for communication to the user. It should also be readily understood that one or more of imager heads 204 do not have an imager.

Turning now to FIGS. 3A and 3B and referring generally thereto, an imager head 300 has more than one imager. For example, the imager head 300 has a first imager 302 and a second imager 304 that are oriented in different directions. The imagers 302 and 304 are oriented orthogonally. User selectable display modes display views captured by one or both of these imagers 302 and 304.

The imager head 300 has head movement position sensors. Flow of the imager head 300 is sensed by optical mouse chip flow sensors 306 combined with lasers 308 emitting laser beams. A 3 axis gyroscope chip 312 and a 3 axis accelerometer chip 314 are also disposed in head 300. It is envisioned that alternative or additional sensors disposed in head 300 include sonar technology with triangulation, differential GPS, gimbal, and/or eyeball ballast.

Returning to FIG. 2C, the cable reel 208 also has a sensor that tracks feeding and/or retracting of the cable reel. In addition to captured images, sensed imager movement is communicated to reel 208 by cable 206. Captured images are then wirelessly communicated by the reel 208 to handheld display 202, together with sensor information provided by the sensors in the imager head and the sensor in the reel 208.

Handheld display 202 employs the sensed imager movements to track the imager head movement over time by using the sensed imager movements to recursively determine the head position. Handheld display 202 records this tracked imager head movement in a computer readable medium as a sequence of imager head positions. Handheld display 202 concurrently tracks imager head movement over time by extracting motion vectors from the captured images and using the motion vectors to recursively determine the head position. Handheld display 202 records this tracked imager head movement in a computer readable medium as a sequence of these imager head positions. Next, handheld display 202 determines the imager head position by comparing the two records of tracked imager head movement. Comparing the two records achieves improved accuracy in determining the imager head position.

Turning now to FIG. 5, calculation of the 3D imager head position is accomplished with a Kalman filter 502. For example, the Kalman filter processes input from a three axis accelerometer 504, gyroscope 506, and optical mouse sensors 508 disposed in the imager head. The Kalman filter also processes input from a deployment sensor 510 on a reel feeding the cable to which the head is attached. Further, the Kalman filter processes input, such as motion vectors, from an optical flow processor 512 that extracts the motion vectors from video images 514 captured during movement of the head.

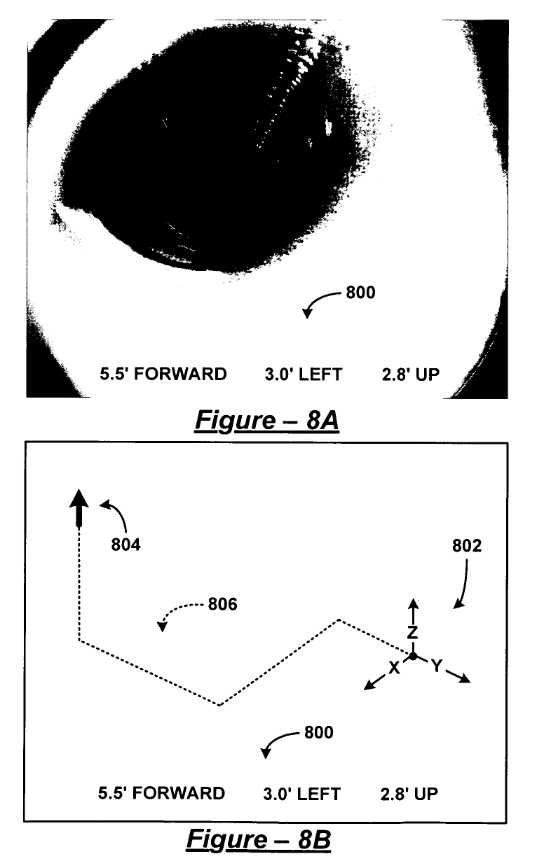

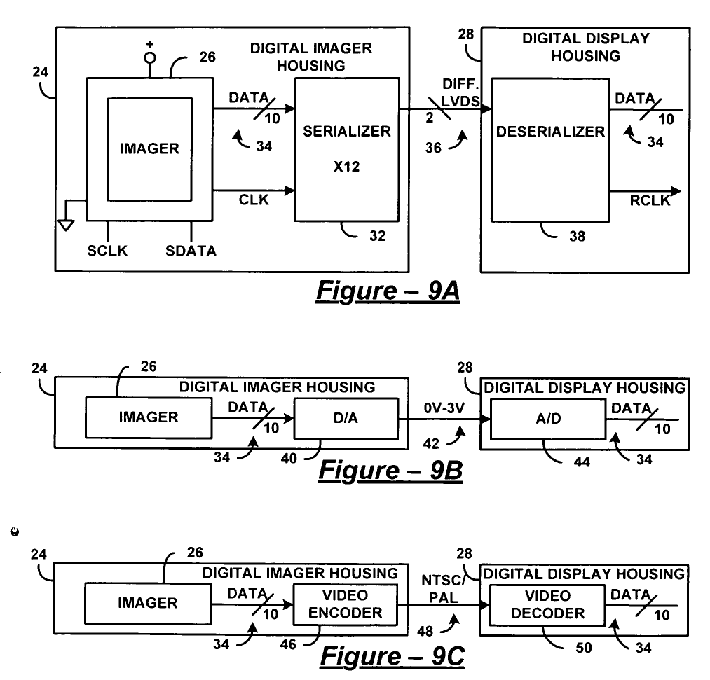

Turning now to FIGS. 8A and 8B and referring generally thereto, an embodiment of the imaging device determines coordinates 800 of the imager head position in a three dimensional coordinate system 802. The coordinates 800 are calculated relative to a starting point 803 at which sensing of imager head movement begins to occur. The starting point 803 is a point at which the head enters a pipe. Example sensors of an appropriate type for sensing position and/or orientation of the imager head include an accelerometer, gyroscope, optical mouse, sonar technology with triangulation, differential GPS, gimbal, and/or eyeball ballast.

One or more markers communicating the imager head position are displayed on the handheld display according to one of plural user selectable modes. In one of the user selectable modes, the coordinates 800 are displayed in an overlay of the captured images (FIG. 8A). In another user selectable mode, an icon 804 (FIG. 8B) indicating position and orientation of the head is displayed in combination with the coordinates 800. The icon 804 is also displayed in combination with a path 806 of travel of the head from the starting point 803 to the current head position indicated by the icon 804 and the coordinates 800. The path 806 is calculated by determining the position of the head over time and recording the head positions in sequence in computer readable memory.

In another embodiment, the starting point is a position of the reel. In this case, the position of the reel and path of the imager head to the pipe are determined by using differential GPS to observe the head and reel positions over time. Once the imager head enters the pipe, the differential GPS of the imager head become less effective for tracking imager head movement, and tracking is thus performed in the pipe by using sensors in the head and/or extracting motion vectors from captured images as described above.

With the imager head position known, the user can determine where to dig or otherwise obtain access to the location of the imager head. With the path 806 of the imager head also known, the user can determine positions of obstacles that need to be avoided in accessing physically obtaining access to a position matching the position of the imager head. This capability, for example, assists a plumber seeking to locate a broken pipe without damaging any other pipes. An access strategy can thus be planned by the user.

Returning now to FIG. 2C, another embodiment employs augmented reality technology to communicate the marker in the user's environmental surroundings. For example, a marker is generated to illustrate the 3D head position and path. Based on the marker illustrating the 3D imager head position and/or path, an augmented reality display 210 that is worn by the user displays the marker to the user. Augmented reality displays allow users to view their surroundings while providing a heads up display that overlays the users' views of their surroundings. Employing the reel as the starting point, the marker is calculated based on information from sensors sensing position and orientation of the augmented reality display 210 and position of the reel 208. Thus, the user persistently experiences the marker despite movement of the display 210.

The marker for the augmented reality display includes an icon representing the imager head. This icon is generated based on position and orientation of the display and the known starting point, which is the sensed position of the reel. The marker representing of the imager head has a size, shape, perspective, orientation, and scale that together communicate to the user the position of the imager head within the user's environmental surroundings. For example, the icon is an arrow facing away from the user at a 45 degree angle. The arrow is graphically rendered to faces up and a base of the arrow is larger than a tip of the arrow in order to communicate the orientation of the arrow. As the user moves towards and away from the head position, rendering of the arrow changes to cause he arrow to appear to grow larger and smaller in order to provide an experience to the user of moving closer to and away from the head position. As the user moves up and down, the appearance of the arrow elongates and foreshortens in order to provide an experience to the user of observing an orientation of the arrow in the user's environmental surroundings that is persistently in accord with the user's position within the environmental surroundings. As a user changes orientation of the display 210 in order to look around in the environmental surroundings, the appearance of the arrow moves up, down, right, and left in order to provide an experience to the user of observing a position of the arrow in the user's environmental surroundings that is persistently in accord with the user's viewing direction in the environmental surroundings.

A path to the imager head from the reel is also rendered that has a size, shape, perspective, orientation, and scale that accurately guides the user from the starting point (i.e., the reel 208) to the position of the imager head within the user's environmental surroundings. Again, size, shape, position, perspective, and orientation of the path are controlled according to the position and orientation of the display 210. The control of the appearance of the path is accomplished to provide an experience to the user of observing the path in the user's environmental surroundings that is persistently in accord with the user's viewing direction and position in the environmental surroundings.

In a user selectable mode of operation, the handheld display 202 operates as an augmented reality display. A camera on a rear of the handheld display 202 captures images of the user's surroundings and displays the images to the user. Then the marker for the head position and path are rendered on by handheld display 202 to overlay the captured images of the user's surroundings. Size, shape, perspective, and orientation of the marker (i.e., icon and path) are controlled in response to the position and orientation of the display. The control of the appearance of the icon and path are accomplished to provide an experience to the user of observing the icon and path in the user's environmental surroundings that is persistently in accord with the handheld display's position and orientation in the user's environmental surroundings. Example sensors appropriate for sensing position and orientation of the augmented reality display, reel, and imager head include an accelerometer, gyroscope, optical mouse, sonar technology with triangulation, differential GPS, gimbal, and/or eyeball ballast.

In a user selectable mode of operation, display 210 and/or display 202 serve as a virtual reality display by providing a view of images captured by the imager, such as a pipe interior. In such embodiments, tracked positions of the display 210 and/or display 202 are employed to control post processing of images for accomplishing virtual reality interaction of the user with the captured images. For example, zooming, panning, and/or image rotation are applied, and the zoomed, panned, and/or rotated image is displayed on display 210 and/or display 202. Thus, the user virtually looks around inside the pipe or other environmental surroundings viewed by the imager. Simultaneously, non-zoomed, non-panned, and/or non-rotated images are displayed to the static display 205. Example sensors appropriate for sensing position and orientation of the handheld display, reel, and imager head include an accelerometer, gyroscope, optical mouse, sonar technology with triangulation, differential GPS, gimbal, and/or eyeball ballast.

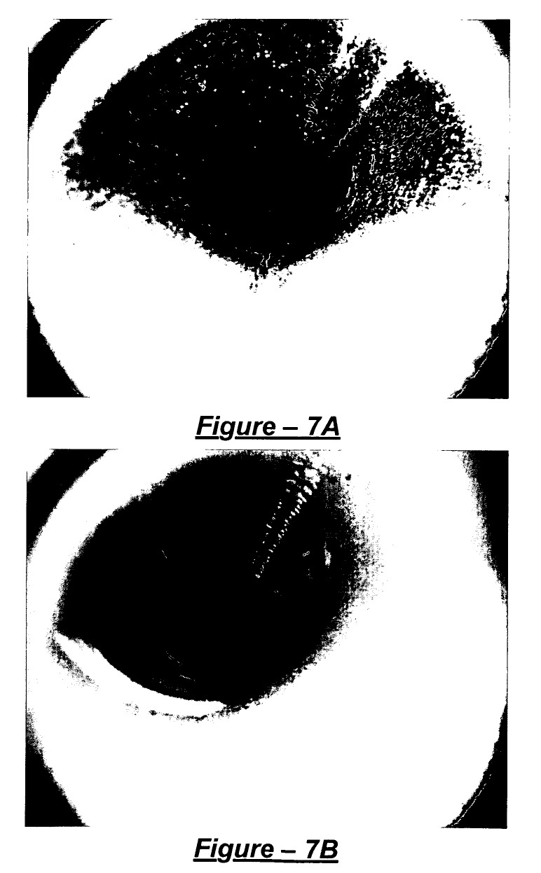

In another user selectable mode of operation, additional image post processing modes are selected by the user. For example, the user selects between a default shutter mode, a nighttime shutter mode, a sports mode, an indoor environment mode, an outdoor environment, and a reflective environment mode. This type of post-processing is applied to images captured by the imager and displayed by worn display 210, handheld display 202, and static display 205 during a virtual reality operation mode. Examples of displays of pipe interiors rendered according to two different imaging modes are illustrated in FIGS. 7A and 7B. The example of the normal viewing mode (FIG. 7A) and the bright viewing mode (FIG. 7B) are just one example. It should be readily understood that these viewing modes and other viewing modes are accomplished by post processing of captured images, changes in light produced by the imager head, head articulation, and/or combinations thereof.

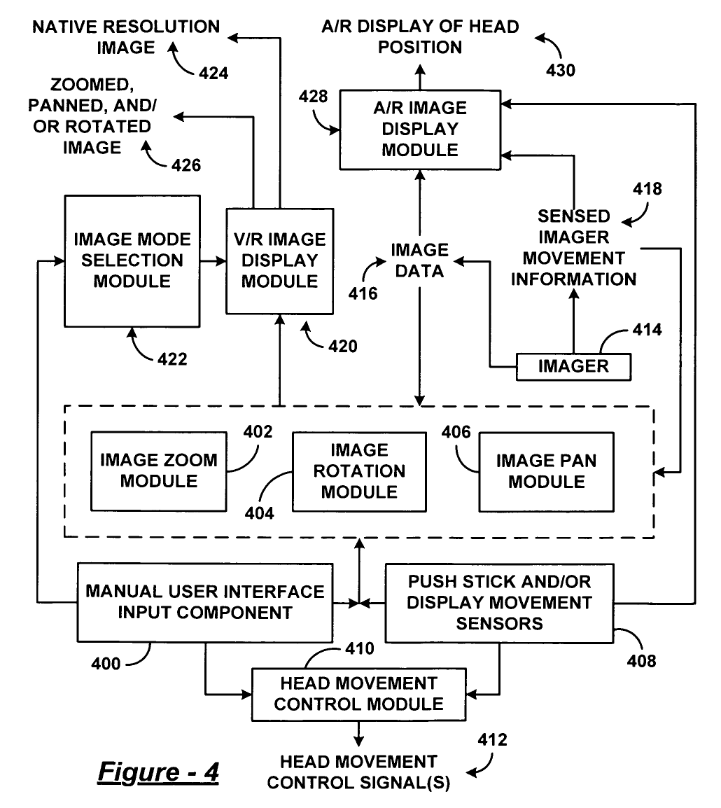

Turning now to FIG. 4, a remote inspection device system includes a manual user interface component 400 on the handheld display communicates user selections to image zoom module 402, image rotation module 404, and/or image pan module 406. Modules 402-406 are stored in computer readable memory of handheld display and/or augmented reality display. Modules 402-406 are also executed by a computer processor residing on the handheld display or augmented reality display. Worn and/or held movement sensors 408 attached to the handheld display and/or augmented reality display communicate user movement of the handheld display or augmented reality display to image zoom module 402, image rotation module 404, and/or image pan module 406. User interface component 400 and/or movement sensors 408 communicate user selections and movement of the display to imager head movement control module 410 residing on the motorized reel. In turn, head movement control module 410 generates one or more head movement control signals 412 that control movement of a head containing an imager 414 supplying image data 416. The control signals 412 operate the motorized reel to control feeding and retraction of the cable. Control signals 412 also operate cables or flex-wire of the cable. The motorized reel further communicates some of the control signals 412 to the imager head by the cable to operate micro-motors of the imager head. For the movement sensors, the accelerometer and gyroscope inputs are acceleration and rotational data (radian) converted to angle and angular measurements. These measurements are converted to control signals (e.g., 15 degrees is 15 degrees).

Image zoom module 402, image rotation module 404, and image pan module 406 cooperate to zoom, pan, and rotate the image in order to accomplish a virtual reality display of a portion of the image data 416. For example, user movement of the display, including pitch and yaw, can affect panning of the image data 416 from side to side and up and down. Also, user movement of the display and actuation of a joystick or button pad of component 400 zoom the image data. Further, zoomed and panned images are rotated by calculated display position and imager position to accomplish an upright display of the image data based on a gravity vector with respect to the imager position and display position. In the case that the head is pointed straight down or straight up, the accelerometer goes into an indeterminate state and is disabled to stay at last input until some kind of rotational change is detected by the accelerometer. A resulting zoomed, panned, and rotated portion 426 of the image data is then provided to virtual reality image display module 420 on the display handheld display or head mounted display for display to the user. The image data 416 is also rotated and provided to display module 420 for communication to the external display as a native resolution image 424.

Image mode selection module 422 receives user selections from manual user interface component 400 and interprets the selections to select image post processing for application to the image data 416 and portion of the image data 426. Accordingly, virtual reality display module 420 applies the selected image post processing to the image data 416 to obtain the portion 426. The rotated image data 424 is supplied at native resolution to the external display, while the post processed, zoomed, panned, and rotated portion of the image data is rendered by the held display and head-mounted display at 426.

Sensed imager movement information 418 and image data 416 are sent from the reel to augmented reality image display module 428 located on the head mounted display. Augmented reality display module 428 tracks imager head position and path by extracting motion vectors from the image data 416 and employing the motion vectors and the sensed imager movement information 418 to determine the imager head position. With the head position and path known, the augmented reality image display module 428 generate a marker 430 to display the head position and path to the user by an augmented reality display component of the head mounted display. This marker 430 is calculated in part based on input from movement sensors 408 on the head mounted display.

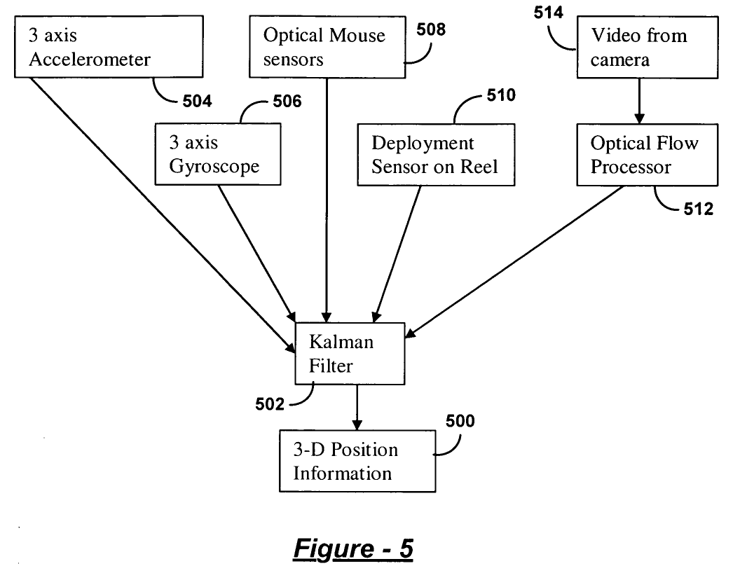

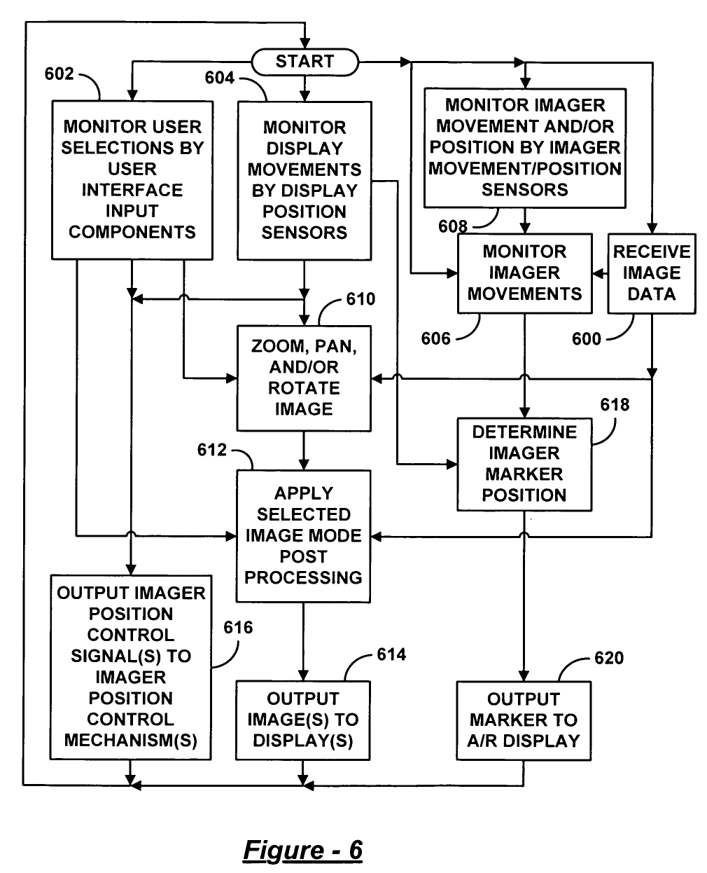

Turning now to FIG. 6, a method of operation for use with a remote inspection device includes receiving image data at step 600 from an imager disposed in an imager head of the remote inspection device. User selections are monitored by user interface input components of a handheld display and head mounted display at step 602. Movements of the handheld display and head mounted display are monitored at step 604 by display position sensors attached to the handheld display and head mounted display. Post processing of the image data occurs at step 610 to pan, zoom, and rotate the image data according to the user selections and display movements. According to a user-selected post processing mode, further post processing of the image data occurs on the handheld display and head mounted display at step 612 to change appearance of the panned, zoomed, and rotated image data. Next, the image data is rendered at step 614 by display components of the handheld display, head mounted display, and external display. Imager position control signals are generated by the handheld display and head mounted display at step 616 based on the user selections and display movements, and these control signals are output to imager position control mechanisms on a motorized reel feeding and retracting the imager head in response to a portion of the control signals. Motorized reel also controls the cable in response to another portion of the control signals. Motorized reel further communicates an additional portion of the control signals to micro-motors on the imager head. These micro-respond to the additional portion of the control signals to control imager head position.

Imager movements are monitored on the handheld display and head mounted display at step 606 during capture of the image data. For example, imager movement is monitored by input from sensors disposed in the imager head at step 608. The sensor input is communicated by the cable to the reel, where it is in turn wirelessly communicated to the handheld display or head mounted display. Imager movement is also detected at step 606 by extracting motion vectors from the image data received at step 600. The motion vectors are extracted by the handheld display and head mounted display. These imager movements are tracked at step 618 by the handheld display and head mounted display in order to calculate a 3D position of the imager head. A marker is then generated at step 618 by the handheld display and head mounted display. The head mounted display generates the marker based on the position and orientation of the head mounted display in order to illustrate the head position and path to the user. The handheld display generates the marker based on the position and orientation of the handheld display in order to illustrate the head position and path to the user. The head mounted display and handheld display render their respective markers by their respective display components.

The preceding description is merely exemplary in nature and is not intended to limit the present disclosure, application, or uses.

What is claimed is:

1. A remote inspection apparatus, comprising:
an imager disposed in an imager head and capturing image data;
an active display unit receiving the image data in digital form and graphically rendering the image data on an active display;
one or more movement tracking sensors tracking movement of the imager head; and
a computer processor located in the active display unit and employing information from the movement tracking sensors to generate and display a marker indicating a position of the imager head.

2. The apparatus of claim 1, wherein the marker includes 3D coordinates of the imager head in a coordinate system having a starting point of the imager head as its origin.

3. The apparatus of claim 1, wherein the marker includes an icon illustrating a position and orientation of the imager head at 3D coordinates of the imager head in a coordinate system having a starting point of the imager head as its origin.

4. The apparatus of claim 1, wherein the marker illustrates a 3D path taken by the imager head from a starting point of the imager head to 3D coordinates of the imager head in a coordinate system having the starting point of the imager head as its origin.

5. The apparatus of claim 1, wherein said computer processor further generates the marker indicating the position of the imager head in response to movement tracking sensors disposed to track movement of said active display unit.

6. The apparatus of claim 5, wherein said active display unit further has an augmented reality display and the marker is rendered by the augmented reality display to overlay a view of a user's environmental surroundings.

7. The apparatus of claim 1, wherein the movement tracking sensors are located on the active display unit and track movement of the imager head by extracting motion vectors from video generated by the imager during movement of the imager head.

8. The apparatus of claim 1, wherein the movement tracking sensors are located on the imager head and include at least one of: an accelerometer, a gyroscope, an optical mouse, sonar technology with triangulation, differential GPS, a gimbal, or an eyeball ballast.

9. The apparatus of claim 1, further comprising a digital image converter receiving the image data and converting the image data to digital form for rendering on the active display, wherein the digital image converter is located on at least one of: the imager head, a motorized reel at least one of feeding or extracting a flexible cable connecting the imager head to the motorized reel; a push stick connected to the imager head by a flexible cable; or said active display unit.

10. The apparatus of claim 1, wherein said movement tracking sensors include a deployment sensor located on a motorized reel at least one of feeding or extracting a flexible cable connecting the imager head to the motorized reel.

11. A remote inspection apparatus, comprising:
an imager disposed in an imager head and capturing image data;
an active display unit receiving the image data in digital form and graphically rendering the image data on an active display;
one or more movement tracking sensors located on the active display unit and tracking movement of said active display unit; and
a computer processor employing input from said movement tracking sensors to control movement of the imager head.

12. The apparatus of claim 11, wherein said computer processor generates an imager head movement control signal and outputs the imager head movement control signal to an imager head movement control mechanism.

13. The apparatus of claim 12, wherein the movement control mechanism includes a motorized reel at least one of feeding or extracting a cable extending the imager head.

14. The apparatus of claim 12, wherein the movement control mechanism includes at least one of: wires that articulate the imager head and are attached to a section of a cable at least one of feeding or extracting the imager head; or flex-wire of the section of the cable that articulates the imager head.

15. The apparatus of claim 12, wherein the movement control mechanism includes micro-motors located in the imager head.

16. The apparatus of claim 11, wherein said movement tracking sensors include at least one of: an accelerometer, a gyroscope, sonar technology with triangulation, differential GPS, a gimbal, or an eyeball ballast.

17. A remote inspection apparatus, comprising:
an imager disposed in an imager head and capturing image data;
an active display unit receiving the image data in digital form and graphically rendering the image data on an active display;
one or more display movement tracking sensors located on said active display unit and tracking movement of said active display unit; and
a computer processor: (a) employing input from said display movement tracking sensors to modify at least part of the image data; and (b) rendering the image data thus modified to the active display.

18. The apparatus of claim 17, wherein said computer processor modifies the image data by at least one of zooming, panning, or rotating the image data in response to the input received from said display movement tracking sensors.

19. The apparatus of claim 17, further comprising:
one or more imager head movement tracking sensors tracking movement of the imager head,
wherein said computer processor further: (a) employs input from said imager head movement tracking sensors to rotate at least part of the image data; and (b) renders the image data thus rotated to the active display.

20. A method of operation for use with a remote inspection device, comprising:
employing an imager disposed in an imager head to capture image data;
receiving the image data in digital form and graphically rendering the image data on an active display;
employing one or more movement tracking sensors to track movement of the imager head; and
employing a computer processor located in the active display unit to use information from the movement tracking sensors to generate and display a marker indicating a position of the imager head.

21. The method of claim 20, wherein the marker includes 3D coordinates of the imager head in a coordinate system having a starting point of the imager head as its origin.

22. The method of claim 20, wherein the marker includes an icon illustrating a position and orientation of the imager head at 3D coordinates of the imager head in a coordinate system having a starting point of the imager head as its origin.

23. The method of claim 20, wherein the marker illustrates a 3D path taken by the imager head from a starting point of the imager head to 3D coordinates of the imager head in a coordinate system having the starting point of the imager head as its origin.

24. The method of claim 20, wherein the computer processor further generates the marker indicating the position of the imager head in response to movement tracking sensors disposed to track movement of said active display unit.

25. The method of claim 24, wherein the active display unit further has an augmented reality display and the marker is rendered by the augmented reality display to overlay a view of a user's environmental surroundings.

26. The method of claim 20, wherein the movement tracking sensors are located on the active display unit and track movement of the imager head by extracting motion vectors from video generated by the imager during movement of the imager head.

27. The method of claim 20, wherein the movement tracking sensors are located on the imager head and include at least one of: an accelerometer, a gyroscope, an optical mouse, sonar technology with triangulation, differential GPS, a gimbal, or an eyeball ballast.

28. The method of claim 20, further comprising employing digital image converter to receive the image data and convert the image data to digital form for rendering on the active display, wherein the digital image converter is located on at least one of: the imager head, a motorized reel at least one of feeding or extracting a flexible cable connecting the imager head to the motorized reel; a push stick connected to the imager head by a flexible cable; or the active display unit.

29. The method of claim 20, wherein the movement tracking sensors include a deployment sensor located on a motorized reel at least one of feeding or extracting a flexible cable connecting the imager head to the motorized reel.

30. A method of operation for use with a remote inspection apparatus, comprising:
employing an imager disposed in an imager head to capture image data;
employing an active display unit to receive the image data in digital form and graphically render the image data on an active display;
employing one or more movement tracking sensors located on the active display unit to track movement of the active display unit; and
employing a computer processor to use input from the movement tracking sensors to control movement of the imager head.

31. The method of claim 30, wherein the computer processor generates an imager head movement control signal and outputs the imager head movement control signal to an imager head movement control mechanism.

32. The method of claim 31, wherein the movement control mechanism includes a motorized reel at least one of feeding or extracting a cable extending the imager head.

33. The method of claim 31, wherein the movement control mechanism includes at least one of: wires that articulate the imager head and are attached to a section of a cable at least one of feeding or extracting the imager head; or flex-wire of the section of the cable that articulates the imager head.

34. The method of claim 31, wherein the movement control mechanism includes micro-motors located in the imager head.

35. The method of claim 30, wherein the movement tracking sensors include at least one of: an accelerometer, a gyroscope, sonar technology with triangulation, differential GPS, a gimbal, or an eyeball ballast.

36. A method of operation for use with a remote inspection apparatus, comprising:
employing an imager disposed in an imager head to capture image data;
employing an active display unit to receive the image data in digital form and graphically render the image data on an active display;
employing one or more display movement tracking sensors on the active display unit to track movement of the active display unit; and
employing a computer processor: (a) using input from the display movement tracking sensors to modify at least part of the image data; and (b) rendering the image data thus modified to the active display.

37. The method of claim 36, wherein the computer processor modifies the image data by at least one of zooming, panning, or rotating the image data in response to the input received from the display movement tracking sensors.

38. The method of claim 36, further comprising:
employing one or more imager head movement tracking sensors to track movement of the imager head,
wherein the computer processor further: (a) employs input from the imager head movement tracking sensors to rotate at least part of the image data; and (b) renders the image data thus rotated to the active display.
